(19) United States
(12) Patent Application Publication
(10) Pub. No.: US 2004/0194064 A1
(43) Pub. Date: Sep. 30, 2004

(54) Generic test harness

(76) Inventors: Mungara Vijay Ranjan, Beaverton, OR (US); Ajay Mohan Mungara, Beaverton, OR (US); David Miller, Hillsboro, OR (US)

Correspondence Address: Blakely Sokoloff Taylor & Zafman, Seventh Floor, 12400 Wilshire Boulevard, Los Angeles, CA, 90025-1030, US

(21) Appl. No.: 10/404,737

(22) Filed: Mar. 31, 2003

(51) Int. Cl. G06F 9/44; G06F 7/00

(52) U.S. Cl. 717/124; 707/1

(57) ABSTRACT

A system, apparatus, and method are provided for providing a test harness application developed to test a software project having distinct functional units. According to one embodiment, the test harness application is used to test the distinct functional units of the software project.

### BACKGROUND OF THE INVENTION

1. Field of the Invention

This invention relates to software development and testing and in particular to, generic Net test harness.

2. Description of the Related Art

Several attempts have been made to improve software testing; however, software testing methods, apparatus, and systems available today primarily rely on manual testing, and often, require multiple testing applications to test all of the software components. Such software testing can be expensive, irregular, and cumbersome, as it requires a great degree of human activities, time, and effort.

Often, software testing is not performed due to the enormous cost and effort required in creating a test environment. Using the methods, apparatus, and systems available today, a separate testing application is required to test each of the functionally distinct units of a software application. Such requirements make unit testing complex and cumbersome, making it very difficult for developers to, for example, perform unit testing and, at the same time, keep the testing application and environment up-to-date with every occurrence of change to the various software components and units. Using the methods, apparatus, and systems available today, even the experts, such as quality assurance (QA) teams and developers, do not have enough expertise or resources to successfully test software units, and simultaneously, maintain and dynamically update multiple testing applications. Furthermore, methods, apparatus, and systems available today do not use the Microsoft .NET Framework (.NET or .NET Framework) and therefore, fail to provide the various benefits of using the .NET Framework.

FIG. 1 is a block diagram illustrating an overview of a typical prior art. As illustrated, a software project (project or application) 102 may include several basic distinct functional units (functional units) 104-108. Each of the functional units 104-108 represents a distinct functionality or component of the project 102. As the project 102 needs to be tested, each of the functional units 104-108 of the project 102 also needs to be tested. Using the methods, apparatus, and systems available today, a developer would have to develop a separate test application 110-114 for each of the functional units 1-3 104-108 that is to be tested. As illustrated, test application 1 110 is developed to test the corresponding functional unit 1 104, test application 2 112 is developed to test the corresponding functional unit 2 106, and test application 3 114 is developed to test the corresponding functional unit 3 108. Hence, at best, the software testing methods, apparatus, and systems available today require developing at least as many test applications 104-108 as there are basic distinct functional units 104-108 of a project 102.

None of the methods, apparatus, or systems available today provide a single test harness application to test all of the basic distinct functional units, such as assemblies, and their sub-functional units, such as functions, of a project, and therefore, requiring extensive manual work to be done by developers and QA teams, and requiring additional expensive resources.

Furthermore, with regard to testing stored procedures, such as a Structured Query Language (SQL) programs stored in a database, none of the conventional methods, apparatus, and systems provide for a Web-based testing application. Most of the stored procedure testing tools available today are Windows-based testing applications, requiring multiple implementations, cost, labor, and still cumbersome to test each of the stored procedures. Moreover, for testing stored procedures in a database of a Web application, conventional testing tools, such as e-Test Suite, are limited to simulation-based testing of a Web application for detecting superficial problems, and are not capable of testing the stored procedures.

Testing methods, apparatus, and systems available today do not use the Microsoft .NET Framework (.NET or .NET Framework) and hence, do not provide the benefits of using the .NET Framework. Without having the benefits of the .NET Framework, test harness application developers and QA teams are often, required, for example, to generate and regenerate, program and reprogram, their test applications each time a component or unit version or build changes. This demands additional resources and maintenance efforts from developers, QA teams, and others, often making it impossible to continue testing because of the complexities involved, particularly in using various programming languages.

### BRIEF DESCRIPTION OF THE DRAWINGS

The appended claims set forth the features of the present invention with particularity. The embodiments of the present invention, together with its advantages, may be best understood from the following detailed description taken in conjunction with the accompanying drawings of which:

FIG. 1 is a block diagram illustrating an overview of a typical prior art;

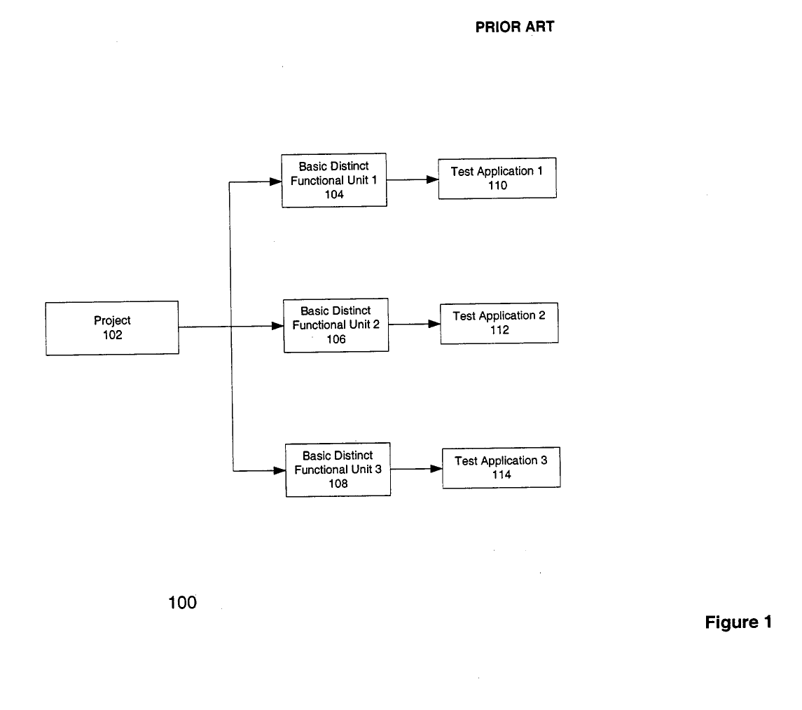

FIGS. 2 is a block diagram of a typical computer system upon which one embodiment of the present invention may be implemented;

FIG. 3 is a block diagram conceptually illustrating an overview of test harness, according to one embodiment;

FIG. 4 is a flow diagram conceptually illustrating a test harness process, according to one embodiment;

FIG. 5 is a block diagram conceptually illustrating a network schema of various test harness components, according to one embodiment;

FIG. 6 is a flow diagram conceptually illustrating a test harness process, according to one embodiment;

FIG. 7 is a block diagram conceptually illustrating an example of test harness, according to one embodiment;

FIG. 8 is a block diagram conceptually illustrating an overview of a test harness, according to one embodiment;

FIG. 9 is a flow diagram conceptually illustrating a test harness process, according to one embodiment;

FIG. 10 is a block diagram conceptually illustrating a network schema of various test harness components, according to one embodiment; and

FIG. 11 is a flow diagram conceptually illustrating a test harness process, according to one embodiment.

### DETAILED DESCRIPTION

A method and apparatus are described for generic test harness of databases and software applications. Broadly stated, embodiments of the present invention allow for testing all of the functional units of a software application and stored procedures of a database with a single test harness application.

A system, apparatus, and method are provided for developing a test harness application for testing assemblies and functions of a project (or application) to be tested. According to one embodiment, only single test harness application may be developed and necessitated for testing all of the necessary assemblies and functions that are to be tested, of an application. Stated differently, although an application may typically have several assemblies, and the assemblies may have several functions, but only a single, once-developed, test harness application may be necessary to test the application and all of its distinct functional units.

According to one embodiment, a test harness application may be created, using the Microsoft NET Framework, for testing an application. A BINary (BIN) directory may be created within the test harness application. Each of the assemblies, functions, and other necessary components, may be copied to the BIN directory of the test harness application. According to one embodiment, a Uniform Resource Locator (URL) may be obtained to provide access to the test harness application for testing the application.

According to one embodiment, a single Web-based test harness application may be created for testing of stored procedures of a database. A user may access the Web-based test harness application by visiting a URL using an Internet browser via the Internet. According to one embodiment, the Web-based test harness application for testing stored procedures may be used with a conventional testing tool for testing Web applications.

According to one embodiment, a system, apparatus, and method are provided for employing Microsoft NET Framework for developing a test harness application. Stated differently, according to one embodiment, the NET Framework may be used as a platform to develop a NET-based, Web-based, test harness application, having all the benefits of the Microsoft NET Framework. The use of the Microsoft .NET Framework may be beneficial to developers, quality assurance (QA) teams, and users of the test harness application.

According to one embodiment, only a single test harness application may be necessitated to test each of the distinct functional units of an application or stored procedures of a database, resulting in a reduction of resources, expenses, implementations, and maintenance needed to perform such testing. Furthermore, according to one embodiment, the use of the Microsoft .NET Framework may provide additional benefits in developing, implementing, and using of the test harness application to the developers, QA teams, and users. The .NET-based test harness application, according to one embodiment, may provide for early detection of software-related problems, resulting in an early opportunity to fix such problems in conforming with the departmental and organizational goals, user goals, customer orientation, effectiveness and efficiency goals, and improved software quality and efficiency. Many other advantages of the embodiments will be mentioned or discussed here or they will be apparent to the one skilled in the art, based on the disclosure provided herein.

In the following description, for the purposes of explanation, numerous specific details are set forth in order to provide a thorough understanding of the present invention. It will be apparent, however, to one skilled in the art, based on the disclosure provided herein, that the embodiments of the present invention may be practiced without some of these specific details. In other instances, well-known structures and devices are shown in block diagram form.

The embodiments of the present invention include various steps, which will be described below. The steps may be performed by hardware components or may be embodied in machine-executable instructions, which may be used to cause a general-purpose or special-purpose processor or logic circuits programmed with the instructions to perform the steps. Alternatively, the steps may be performed by a combination of hardware and software.

The embodiments of the present invention may be provided as a computer program product that may include a machine-readable medium, having stored thereon instructions which may be used to program a computer (or other electronic devices) to perform a process according to the present invention. The machine-readable medium may include, but is not limited to, floppy diskettes, optical disks, compact disc read-only memories (CD-ROMs), and magneto-optical disks, ROMs, random access memories (RAMs), erasable programmable read-only memories (EPROMs), electrically erasable programmable read-only memories (EEPROMs), magnetic or optical cards, flash memory, or other type of media/machine-readable medium suitable for storing electronic instructions. Moreover, the present invention may also be downloaded as a computer program product, wherein the program may be transferred from a remote computer (e.g., a server) to a requesting computer (e.g., a client) by way of data signals embodied in a carrier wave or other propagation medium via a communication link (e.g., a modem or network connection). Accordingly, a carrier wave or other propagation medium shall be regarded as comprising a machine-readable medium for the purpose of the present specification.

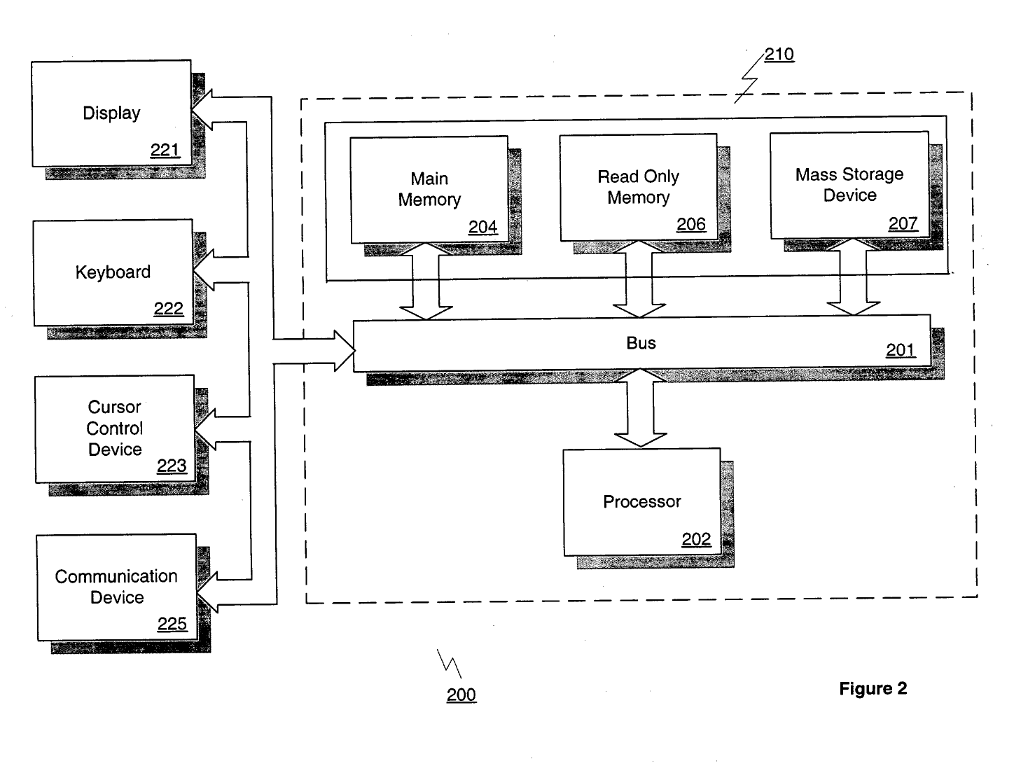

FIG. 2 is a block diagram of a typical computer system upon which one embodiment of the present invention may be implemented. Computer system 200 includes a bus or other communication means 201 for communicating information, and a processing means such as processor 202 coupled with bus 201 for processing information. Computer system 200 further includes a random access memory (RAM) or other dynamic storage device 204 (referred to as main memory), coupled to bus 201 for storing information and instructions to be executed by processor 202. Main memory 204 also may be used for storing temporary variables or other intermediate information during execution of instructions by processor 202. Computer system 200 also includes a read only memory (ROM) and/or other static storage device 206 coupled to bus 201 for storing static information and instructions for processor 202.

A data storage device 207 such as a magnetic disk or optical disc and its corresponding drive may also be coupled to computer system 200 for storing information and instructions. Computer system 200 can also be coupled via bus 201 to a display device 221, such as a cathode ray tube (CRT) or Liquid Crystal Display (LCD), for displaying information to an end user. Typically, an alphanumeric input device 222, including alphanumeric and other keys, may be coupled to bus 201 for communicating information and/or command selections to processor 202. Another type of user input device is cursor control 223, such as a mouse, a trackball, or cursor direction keys for communicating direction information and command selections to processor 202 and for controlling cursor movement on display 221.

A communication device 225 is also coupled to bus 201. The communication device 225 may include a modem, a network interface card, or other well-known interface devices, such as those used for coupling to Ethernet, token ring, or other types of physical attachment for purposes of providing a communication link to support a local or wide area network, for example. In this manner, the computer system 200 may be coupled to a number of clients and/or servers via a conventional network infrastructure, such as a company's Intranet and/or the Internet, for example.

It is appreciated that a lesser or more equipped computer system than the example described above may be desirable for certain implementations. Therefore, the configuration of computer system 200 will vary from implementation to implementation depending upon numerous factors, such as price constraints, performance requirements, technological improvements, and/or other circumstances.

It should be noted that, while the steps described herein may be performed under the control of a programmed processor, such as processor 202, in alternative embodiments, the steps may be fully or partially implemented by any programmable or hard-coded logic, such as Field Programmable Gate Arrays (FPGAs), transistor-transistor logic (TTL) logic, or Application Specific Integrated Circuits (ASICs), for example. Additionally, the method of the present invention may be performed by any combination of programmed general-purpose computer components and/or custom hardware components. Therefore, nothing disclosed herein should be construed as limiting the present invention to a particular embodiment wherein the recited steps are performed by a specific combination of hardware components.

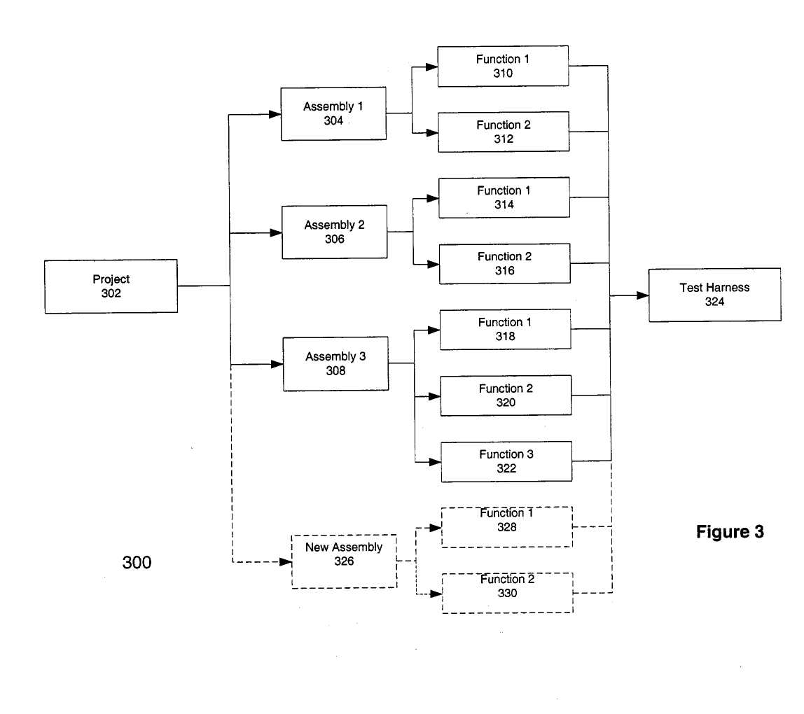

FIG. 3 is a block diagram conceptually illustrating an overview of test harness, according to one embodiment. As illustrated, a software project or application (project or application) 302 may include several basic distinct function units (functional units or distinct functional units), such as assemblies 304-308, to be tested. Assemblies 304-308 may be referred to as current (or old) assemblies. There may also be new assemblies 326 or updated current assemblies added to the project 302 with time. An assembly 304-308, 326, according to one embodiment, may include a form of a distinct unit of functionality, deployment, version control, reuse, activation scoping, and security permissions of a project 302. Assemblies 304-308, 326 may take the form of an executable (.exe) file or dynamic link library (.dll) file, and may be used as building blocks for the .NET Framework. Furthermore, assemblies 304-306, 326 may provide the common language runtime with the information needed to be aware of type implementations. Stated differently, assemblies 304-306, 326 may be a collection of types or resources, each of which may form a logical and distinct unit of functionality of the project 302, that are built to work together.

With Visual Basic NET, for example, contents of assemblies 304-308, 326 may be used and references may be added to them, similar to, for example, using type libraries with previous versions of Visual Basic. However, assemblies 304-308, 326 may differ from .exe or/and .dll files in earlier versions of Windows, in that they contained all the information one would need to find in a type library, plus information relevant to what else may be necessary to use an application 302.

According to one embodiment, an assembly 304-308 may include one or more of .exe or .dll files that make up, for example, a Visual Studio application. When the Visual Studio source files are compiled, assemblies 304-308 may be created automatically. An application 302 may have multiple assemblies 304-308, 326 ranging in number between 10 and 20. To use an assembly 304-308, 326, according to one embodiment, a reference may be added to the assembly 304-308, 326. For example, Visual Studio .NET provides a listing of all .NET Framework and other components available for referencing, and a listing of all reusable components created in local projects. Furthermore, an assembly 304-308, 326 may contain multiple namespaces. Namespaces may be used to organize the objects defined in an assembly 304-308, 326 to prevent ambiguity and to simplify references when using large groups of objects, such as Microsoft .NET class libraries. For example, Visual Studio .NET may define the ListBox class in the System.Windows.Forms namespace, as shown by the following code fragment: Dim Lbox As System.Windows.Forms.ListBox. Also, namespaces may be imported from various projects using an Imports statement.

Microsoft NET employs a naming scheme that uses dot syntax to connote a hierarchy. For example, the first part of the name may refer to the namespace name, and the last part of the name may be the type name. A name such as Microsoft.Excel may represent CompanyName.TechnologyName hierarchy. Furthermore, the .NET namespace may include classes representing the base data types used by various applications, such as Array, Byte, Char, and Object. Once an assembly 304-308, 326 is referenced and imported, all the accessible classes, properties, methods, and other members of its namespaces may be available for the test harness application 324 as if their code were part of the source file.

Referring to FIG. 3, according to one embodiment, an assembly 304-308, 326 may include one or more functions 310-322, 328-330. A function 310-322, 328-330 may be referred to as a distinct sub-functional unit to a basic distinct functional unit, such as an assembly 304-308, 326. For example, as illustrated, current assembly 1 304 may include two functions 1-2 310-312, currently assembly 2 may include functions 1-2 314-316, and current assembly 3 308 may include functions 1-3 318-322. According to one embodiment, the project 302 may have an updated or new assembly 326 comprising functions 1-2 328-330.

To analogize, for example, a shopping cart application on the Web may include several assemblies, such as CreditCardValidator, Customer, Inventory, or such. An assembly, such as CreditCardValidator, may have several functions, such as VerifyExperationDate or VerifyBillingAddress. Similarly, a new assembly 326, such as ContactInformation, may be added with its own functions 328-330, such as CustomerServiceAddress and CustomerServicePhone. The generic test harness, according to one embodiment, may necessitate only a one-time setup of a test harness application 324 to test all of the assemblies 304-308, 326 and functions 310-322, 328-330 of the project 302. According to one embodiment, all assemblies 304-308, 326 and their functions 310-322, 328-330, and other necessary components, may be copied to the BINary (BIN) directory of the test harness application 324 for testing.

According to one embodiment, conventional technologies may be used, together with any desirable modifications that will be apparent to those skilled in the art. For example, the system 300 may include a conventional processor or machine to execute instructions, a conventional memory to store data, conventional encoder to encode data, a conventional transmitter to transmit data, a conventional receiver to receive data, and a conventional decoder to decode data. Without limitation, data may be converted uncompressed to compressed format, and transmitted over air.

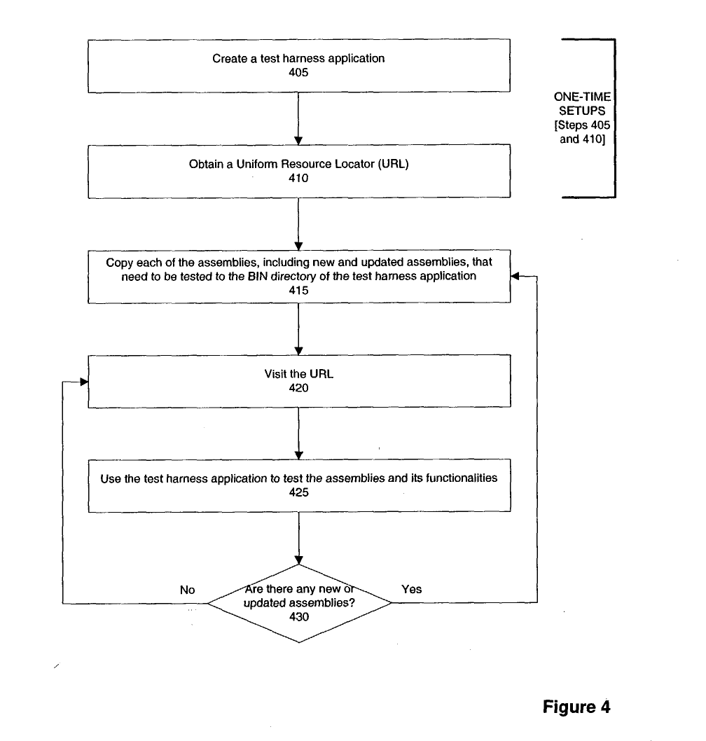

FIG. 4 is a flow diagram conceptually illustrating a test harness process, according to one embodiment. According to one embodiment, .NET Framework (or .NET or dot-Net) may be employed to perform a test harness process. Microsoft .NET provides a framework to connect information, people, systems, and devices. Dot-Net Framework may be referred to as a programming model, tool, or platform of the .NET environment for, for example, building, deploying, and running various applications, such as Web-based applications, smart client applications, and Extensible Markup Language (XML) Web services. Various components and software may be developed using multiple programming languages using the .NET Framework. Some of the benefits of using the .NET Framework include reusability, stability, scalability, and having a center for software development and testing.

According to one embodiment, Microsoft .NET Framework may be used as a programming model to enable developers to develop applications, such as Web-based applications, smart client applications, and XML Web services applications, which expose their functionality over a network using standard protocols, such as Simple Object Access Protocol (SOAP) and Hyper Text Transfer Protocol (HTTP). The use of the .NET as a developer tool, such as using Microsoft Visual Studio .NET, may provide a fast application integrated development environment for programming. Several servers, such as Microsoft SQL Server, Microsoft Windows 2000, and Microsoft BizTalk Server may be used to integrate, run, operate, and manage, for example, XML Web services and applications. Additionally, client software, such as Windows XP, Microsoft Office XP, and Windows CE, may be used to help developers deliver a user experience across a family of devices and existing products.

According to one embodiment, first, to test a software project (project or application), a test harness application may be created or setup at processing block 405. According to one embodiment, only a single, once-developed, test harness application may be necessary for testing all of the distinct functional units of a project. The distinct functional units may include basic distinct function units, such as assemblies, and distinct sub-functional units, such as functions, of the project. The assemblies and functions to be tested with the test harness application may also include new and updated assemblies and functions. At processing block 410, a Uniform Resource Locator (URL) may be obtained or generated for a user to access the test harness application. According to one embodiment, only a single, once-obtained, URL may be necessary for accessing the test harness application. The URL may be created or designed to route the test harness application on the Web or other Internet facilities. According to one embodiment, the URL may be typed into a browser, such as the Internet Explorer or Netscape Navigator, to access the Web page having the test harness application.

According to one embodiment, multiple URLs may be obtained to provide other features, such as related information or guidelines. The Web page may be embedded with various other URLs to provide hypertext links to other pages. Furthermore, the URL may contain protocol prefix, port number, domain name, subdirectory names and file name. Typically, to access a Web page, only the protocol and domain name may be required. According to one embodiment, a URL, similar to http://WebServerName/TestHarness, may be obtained. The user accessing the test harness application may include an individual user, a group of users, a department or organization, a developer or development team, a programmer or programming team, a quality assurance (QA) team, and such, or a combination thereof.

According to one embodiment, a BINary (BIN) directory may be created as part of setting up the test harness application. A BIN directory may include a directory for storing executable programs, device drivers, binary files, and such. The .BIN extension may be used for a variety of binary files, including graphics and other non-text files. Typically, a project may have 10-20 assemblies to be tested. According to one embodiment, each of the assemblies and functions of the project may be copied to the BIN directory of the test harness application at processing block 415.

According to one embodiment, once the URL is created, a user may access the Web page by visiting the URL at processing block 420. The test harness application may, by now, have all the necessary components, assemblies, and functions copied to the BIN directory. Stated differently, all essential test components dependencies may be setup on the Web server to perform test harness. At processing block 425, the user may use the test harness application, i.e., start testing the assemblies and functions using a single test harness application.

According to one embodiment, at decision block 430, whether any new assemblies have been added to the project, or any of the current assemblies have been updated, is determined. If there are no new or updated assemblies, the user may continue testing the current assemblies by visiting the URL at processing block 420. However, if there are new or updated assemblies, such new and updated assemblies may be copied to the BIN directory of the test harness application for testing at processing block 415. According to one embodiment, only one time setup of the test harness application and the URL may be necessitated to test all of the assemblies of the project to be tested.

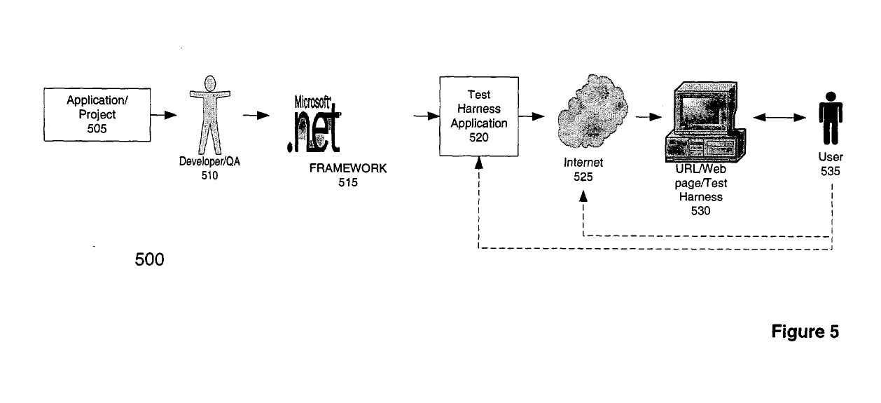

FIG. 5 is a block diagram conceptually illustrating a network schema of various test harness components, according to one embodiment. As illustrated, some of the relevant components, according to one embodiment, include the following: a project (or application) 505 to be tested, a developer 510 to create a test harness application 520 using the Microsoft .NET Framework (.NET or .NET Framework) 515, a Uniform Resource Locator (URL)/Web page 530, the Internet 525, and a user 535 to test the project 505 by accessing the test harness application 520 via the URL 530 using the Internet 525.

According to one embodiment, a project 505 may be any software application or program designed for various purposes. An application 505 may have one or more assemblies, and each of the assemblies having one or more functions. Each of the assemblies and functions may represent a distinct unit or functionality of the project 505. According to one embodiment, each of the assemblies may have an assembly manifest, which may be similar to a table of contents, comprising one or more of the following: (1) the assembly's identity, i.e., its name and version; (2) a file table describing files that make up the assembly, including, for example, any other assemblies that may have been created that the executable (.exe) or dynamic link library (.dll) files, or even bitmap or Readme files, may rely on; (3) an assembly reference list, which may be a list of external dependencies, .dll or other files, that the application may need; and, (4) information with regard to content, versioning, and dependencies, and so, the test harness application 520 created with, for example, Visual Basic NET may not have to rely on registry values in order to function properly. Furthermore, according to one embodiment, assemblies may reduce .dll conflicts and make the test harness application 520 more reliable and easy to deploy. According to one embodiment, a .NET-based test harness application 520 may be installed by copying the files to the target computer or server.

A developer or quality assurance (QA) team 510 may be assigned the responsibility to create the test harness application 520 to test the project 505. According to one embodiment, a typical developer/QA 510 may be a programmer, a software developer, a software engineer, a software specialist, a group of programmers or developer or engineers or specialists, a QA department or team within an organization or externally hired or contracted to develop software, to program, and to test to ensure that various software and/or hardware products and/or systems perform as originally specified and/or designed. A developer 510 may have access to certain databases, sources, resources, components, and functions of a system or organization that may be restricted to non-developers.

According to one embodiment, developer 510 may use the .NET Framework 515 to develop a .NET-based test harness application 520. Microsoft .NET Framework 515 may be referred to as a programming model or tool or platform of the .NET environment for use with building, deploying, and running Web-based applications, smart client applications, and Extensible Markup Language (XML) Web services. The .Net Framework 515 manages the plumbing and enables the developers 510 to focus on writing the business logic code for their applications.

The .NET Framework 515 includes the common language runtime and class libraries. Common language runtime may be considered as an agent that provides code management at execution time, memory management, thread management, and remoting, and other features to ensure security and robustness. Class library, on the other hand, may be a comprehensive, object-oriented collection of reusable types that may be used to develop applications ranging from traditional command-line or graphic user interface (GUI) applications to applications based on the latest innovations provided by enhanced .NET-based Active Server Page (ASP.NET), such as Web Forms and XML Web services. According to one embodiment, the use of the .NET Framework 515 for developing the test harness application 520 may provide the developers 510 with various .NET advantages, such as writing applications using a development language of choice, while taking full advantage of the runtime, the class library, and components written in other languages by other developers.

According to one embodiment, a user 535 may visit the URL 530 to access the test harness application 520 via the Internet 525. The user 535 may use the test harness application 520 to test all of the functional units, such as assemblies and functions, of the project 505. The frequency of accessing the test harness application 520 may depend on various factors, such as testing necessities and system capabilities. According to one embodiment, the test harness application 520 may be a traditional ActiveX control or managed Windows Forms control application deployed over the Internet 525 as a Web page to be accessed using a URL 530, such as http://WebServerName/TestHarness. Such an application may provide access to local resources, and graphic elements. The .NET Framework 515 may help include and incorporate features of various products, such as Microsoft Foundation Classes (MFC) and rapid application development (RAD) environment, such as Microsoft Visual Basic, into a single development environment that may be consistent and help simplify the development of applications, such as the test harness application 520. According to another embodiment, the test harness application 520 may be a traditional style of application in Windows-based programming, enabling a user 535 to perform various tasks, such as testing, using, for example, GUI-tools. Examples of traditional Widows-based applications include Microsoft Word, Microsoft Excel, various data entry and reporting applications, and such. Windows-based applications may include various tools, such as GUI-based windows with menus and buttons, tool bars, and other screen menu, with access to peripherals, such as keyboards, mice, and printers.

According to one embodiment, the test harness application 520 may be developed using various server environments, such as Microsoft Internet Information Server (IIS) and Microsoft SQL sever, for performing standard operations. ASP.NET may host an environment to enable developers 510 to use the NET Framework 515 to generate a Web-based test harness application 520 targeted for Internet browsers, such as the Internet Explorer and Netscape Navigator.

According to one embodiment, a Web server may be employed, which may include a computer for providing World Wide Web on the Internet. In addition to the necessary hardware, the Web server may have, for example, an operating system, necessary software, Transmission Control Protocol/Internet Protocol (TCP/IP), and Web pages. A Web server may also include an internal server, such as an intranet server. On the other hand, a Web server may also refer to software and not a computer or a computer system. A Web server may refer to a Hyper Text Transport Protocol (HTTP) server managing Web page requests from the browser, and delivering Hyper Text Markup Language (HTML) documents, such as Web pages, in response. According to one embodiment, Web servers/computer systems providing the Internet and the Internet-related services may include a HTTP server for Web pages, a File Transfer Protocol (FTP) server for file transfer and downloads over the Internet, a Network News Transfer Protocol (NNTP) server for connecting to Usenet groups on the Internet, and Simple Mail Transfer Protocol (SMTP) server for mail service.

According to one embodiment, severs, applications, systems, databases, and various other hardware/software-related apparatus and components may be physically and/or logically coupled and/or integrated. For example, some of the servers may reside remotely from others and may be linked wirelessly or coupled in some other way.

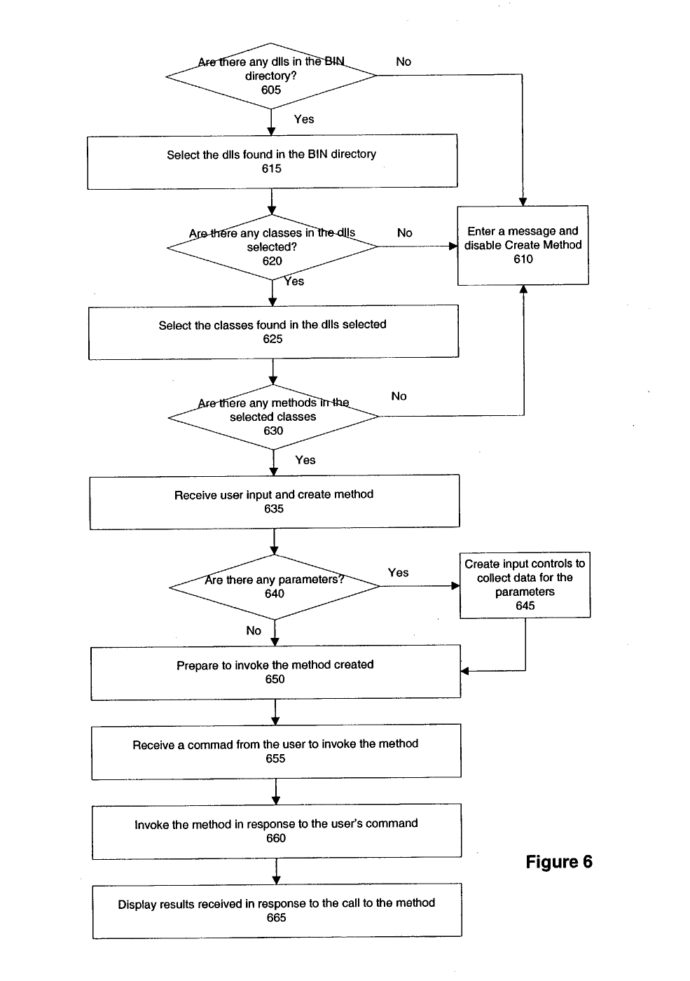

FIG. 6 is a flow diagram conceptually illustrating a test harness process, according to one embodiment. According to one embodiment, a developer may develop a single test harness application to test all of the assemblies and functions of a project (or application) using the Microsoft .NET Framework. According to one embodiment, a BINary (BIN) directory may be created as part of the test harness application. Using the BIN directory, the assemblies and functions of the application may be copied to the BIN directory of the test harness application, and all of the necessary component dependencies may be setup on the Web server to perform test harness. According to one embodiment, a Uniform Resource Locator (URL) may be generated for a user to access and use the test harness application.

Languages, including the three Visual Studio .NET languages, such as Managed Extensions for C++, Visual Basic, and C#, may be used to develop any number of test harness-related programs. Furthermore, most of the programming features based on .NET may be the same for all compatible languages, as supported compilers for the languages may produce the Microsoft intermediate language (MSIL) code. Different languages, such as C++, Visual Basic, and C#, may be used to create and call components written in any .NET runtime compatible language.

According to one embodiment, dynamic link library (dll) files in the BIN directory are determined at decision block 605. Typically, a dll is an executable program module that performs a certain function, and may be written so that its routines may be shared by a number of applications, simultaneously. If no dlls are found in the BIN directory, a message may be entered and so, methods may not be created; for example, the Create Method option may be disabled, at processing block 610. However, if dlls are found in the BIN directory, they may be selected at processing block 615. At decision block 620, classes in the dlls selected are determined. If classes are not found, a message may be entered and so, methods may not be created at processing block 610. If classes are found in the dlls selected, the classes found are selected at processing block 620. At decision block 630, methods in the selected classes are determined. If not found, a message may be entered and so, methods may not be created at processing block 610. If found, according to one embodiment, user input may be received and a method may be created in response to the user input at processing block 635.

According to one embodiment, at decision block 640, parameters are determined. Typically, a parameter may refer to a value used to customize a program for a variety of reasons and purposes, such as organizational necessities, use of the program, system capabilities, user needs, predetermined policy or criteria, and such, or a combination thereof. A parameter may be a coordinate, a file name, a range of values, or a code. Parameters may be required or they may be optional. If the parameters are not found, preparation to invoke the method created begins at processing block 650. If the parameters are found, input controls may be created to receive user input to collect data for the parameters found at processing block 645, and, preparation to invoke the method created begins at processing block 650.

According to one embodiment, waiting for receiving a command from a user begins, and, the command is received from the user for invoking the method at processing block 655. The method may be invoked in response to the command received from the user, at processing block 660. Finally, results, including errors or in some cases, only errors, may be received in response to the call to the method and they may be displayed at processing block 665.

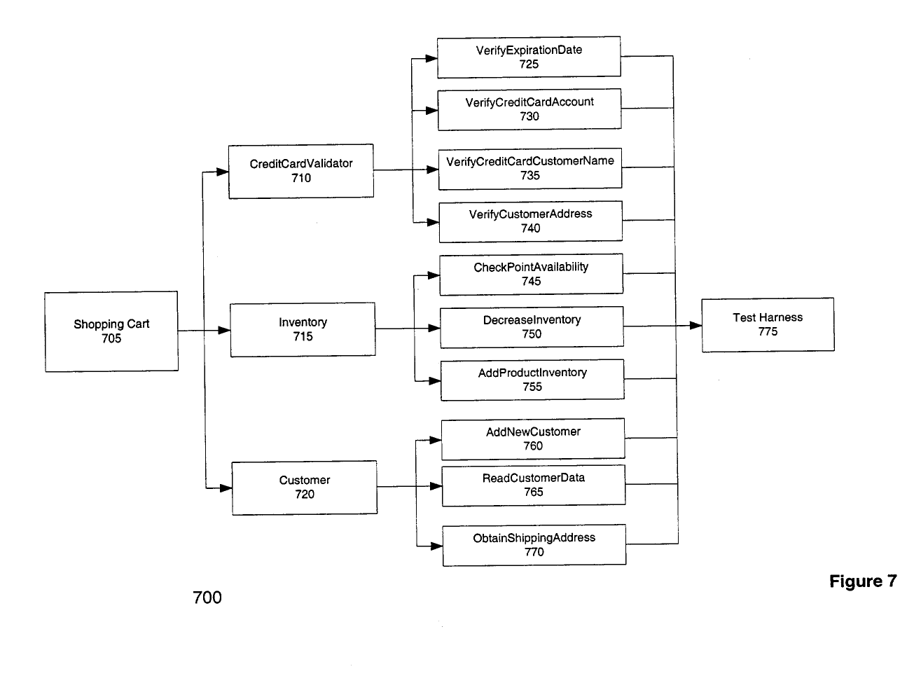

FIG. 7 is a block diagram conceptually illustrating an example of test harness, according to one embodiment. As illustrated, a popular Web application, such as shopping cart 705, may be tested using the test harness application 775, according to one embodiment. The shopping cart application 705 may include several assemblies 710-720, each of them forming a basic distinct functional unit of the shopping cart application 705. For example, shopping cart 705 may include CreditCardValidator 710, Inventory 715, and Customer 720 assemblies. Each of the assemblies 710-720 may include one or more functions 725-770, each of them representing a distinct sub-functional unit of the shopping cart application 705. For the shopping cart application 705 to perform according to its original specification, each of the assemblies 710-720 and functions 725-770 may need to be tested.

As illustrated, CreditCardValidator 710 may include several functions, such as VerifyExperationDate 725, VerifyCreditCardAccount 730, VerifyCreditCardCustomerName 735, and VerifyCustomerAddress 740. Similarly, Inventory 715 may include functions like CheckProductAvailability 745, DecreaseInventory 750, and AddProductlnventory 755. Finally, the assembly of Customer 720 may have functions, such as AddNewCustomer 760, ReadCustomerData 765, and ObtainShippingAddress 770.

According to one embodiment, VerifyCreditCardAccount 730 of CreditCardValidator 710 may need to be tested to verify a number of items, such as customer credit, unpaid balances, cash withdrawals, and such, by accepting, for example, the credit card number and the expiration date. The function of VerifyCreditCardAccount 730 may be represented as follows: VerifyCreditCardAccount(CreditCardNumber as Number, ExpirationDate as Date).

According to one embodiment, generic test harness application 775 may be developed using the Microsoft .NET Framework. Only a single test harness application 775 may be necessary to test all of the assemblies 710-720 and functions 725-770 of the shopping cart application 705. Assemblies, such as CreditCardValidator 710 may be copied to the test harness application's 775 BINary (BIN) directory. As with CreditCardValidator 710, other assemblies 715-720 may also be copied to the BIN directory of test harness application 775. A user may use a Web browser, such as the Internet Explorer or Netscape Navigator, to access the test harness application 775 via a Uniform Resource Locator (URL) to perform the task of testing the shopping cart application 705.

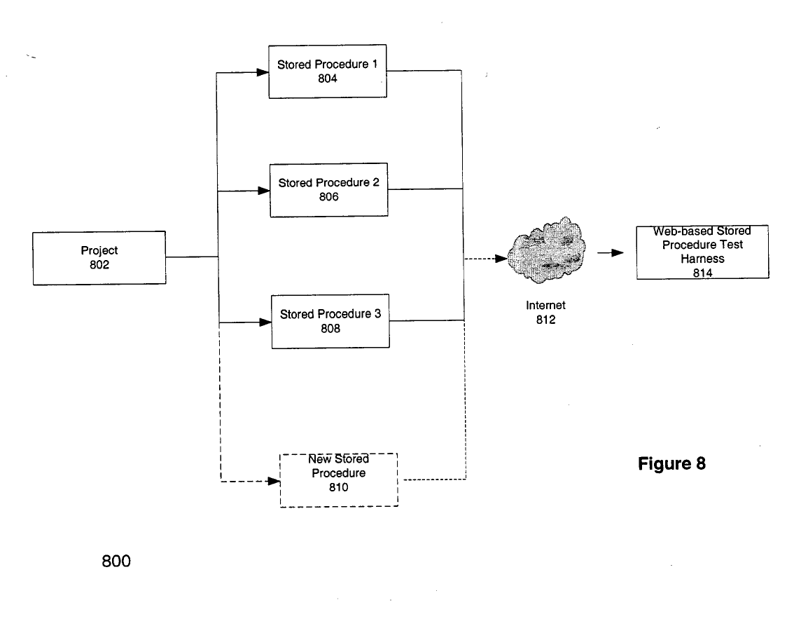

FIG. 8 is a block diagram conceptually illustrating an overview of a test harness, according to one embodiment. As illustrated, project (project or database) 802 may include several stored procedures 804-810 to be tested. A project 802 may refer to a Structured Query Language (SQL) server-based instance database. An SQL server-based instance may have multiple databases, and the project 802 may refer to any of the multiple databases. Examples of such databases include employee database, department database, and customer database within an organization.

A stored procedure 804-808 may refer to a SQL program stored in a database 802 which may be executed by getting called from a client or from a database trigger. Stored procedures 804-810 may be built into a database management system (DBMS) used in a client/server environment. Stored procedures 804-808 may be referred to as current (or old) stored procedures. There may also be new stored procedures 810 or updated current procedures added to the project 802 with time. Each of the stored procedures 804-810 may represent a distinct functional unit of the project 802. According to one embodiment, a Web-based test harness application 814 may be generated to test the project 802, and a single, once-developed, test harness application 814 may be necessary to test all of the stored procedures 804-810.

According to one embodiment, conventional technologies may be used, together with any desirable modifications that will be apparent to those skilled in the art. For example, the system 800 may include a conventional processor or machine to execute instructions, a conventional memory to store data, conventional encoder to encode data, a conventional transmitter to transmit data, a conventional receiver to receive data, and a conventional decoder to decode data. Without limitation, data may be converted uncompressed to compressed format, and transmitted over air.

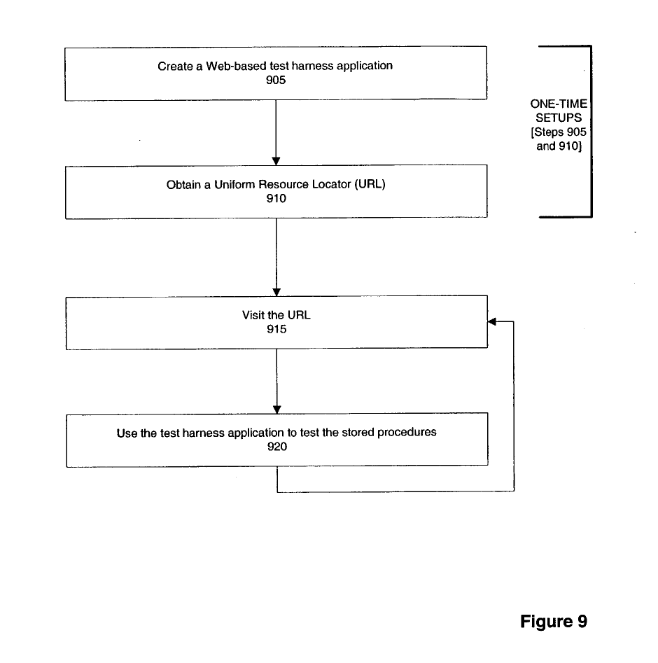

FIG. 9 is a flow diagram conceptually illustrating a test harness process, according to one embodiment. According to one embodiment, first, to test a project (project or database), a Web-based test harness application may be created or setup at processing block 905. According to one embodiment, a single, once-developed, test harness application may be necessary for testing all of the stored procedures of the project. At processing block 910, a Uniform Resource Locator (URL) may be obtained or generated for a user to access the Web-based test harness application. According to one embodiment, only a single, once-obtained, URL may be necessary for accessing the test harness application. The URL may be created or designed to route the test harness application on the Web or other Internet facilities. URL may be typed into a browser, such as the Internet Explorer or Netscape Navigator, to access the Web page having the test harness application.

According to one embodiment, a user may access the Web page having the Web-based test harness for testing stored procedures by visiting the URL at processing block 915. The test harness application may, by now, have all the necessary components, component dependencies, stored procedures, and functions. At, processing block 920, the user may use the Web-based test harness application to test all of the stored procedures of the project. The user may continue testing by accessing the URL at processing block 915. According to one embodiment, if there are any new or updated stored procedures, they may also be available for testing using the same Web-based stored procedure test harness application.

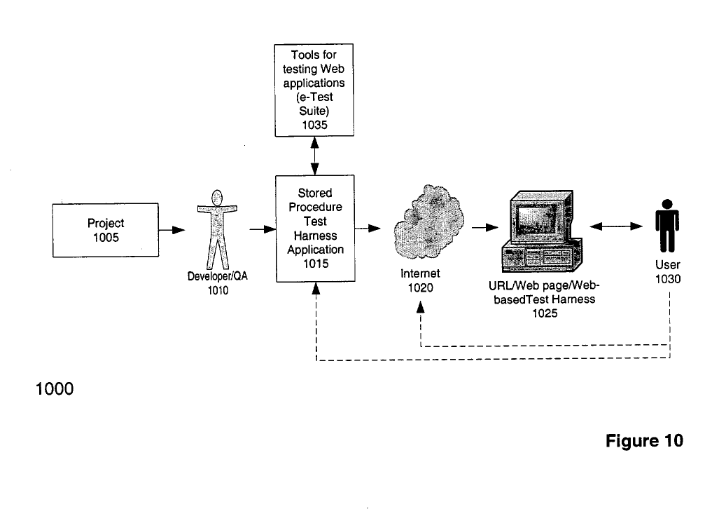

FIG. 10 is a block diagram conceptually illustrating a network schema of various test harness components, according to one embodiment. As illustrated, some of the relevant components, according to one embodiment, include the following: a project (project or database) 1005 to be tested, a developer 1010 to create a Web-based test harness application 1015, a Uniform Resource Locator (URL)/Web page 1025, the Internet 1020, and a user 1030 to test the project 1005 by accessing the test harness application 1015 using the URL 1025 via the Internet 1020.

According to one embodiment, a testing tool 1035 designed for testing Web applications may used with the test harness application 1015 for testing of the stored procedures. An example of a Web application testing tool 1035 includes e-Test Suite. A testing tool 1035, such as e-Test Suite, provides the user with a bunch of tools to stress test a Web application before it is available for use by the users. Stress test may refer to testing of a Web application to identify potential problems with the Web application related to the actual use of the Web application. For example, if the average response time on a website is more the 8-10 seconds, a user may disregard the website, or what happens if over million users decide to access the website all at once.

Problems relating to average response time or number of users access a Web application may be identified using various Web application testing tools 1035; however, such stress testing is limited to simulated testing and identifying only the superficial problems with the Web application. According to one embodiment, the stored procedure test harness application 1015 may be used with the testing tool 1035 to enable the testing tool 1035 to not only perform its expected function, but also test stored procedures for problems that may embedded in the stored procedures of various databases 1005 of a Web application.

A developer or quality assurance (QA) team 1010 may be assigned the responsibility to create the Web-based test harness application 1015 to test the stored procedures of the project 1005. According to one embodiment, a URL 1025 may be obtained so that a user 1030 may use the URL 1025 to access the Web-based test harness application 1015 via the Internet 1020 to test the project 1005, using an Internet browser, such as the Internet Explorer or Netscape Navigator. The frequency of accessing the test harness application 1015 or testing may depend on various factors, such as testing necessities and system capabilities. According to one embodiment, the URL 1025 may be similar to: http://WebServerName/SPTestHarness. According to one embodiment, Microsoft NET Framework may be used as a platform to develop the stored procedure test harness application 1015.

According to one embodiment, severs, applications, systems, databases, and various other hardware/software-related apparatus and components may be physically and/or logically coupled and/or integrated. For example, some of the servers may reside remotely from others and may be linked wirelessly or coupled in some other way.

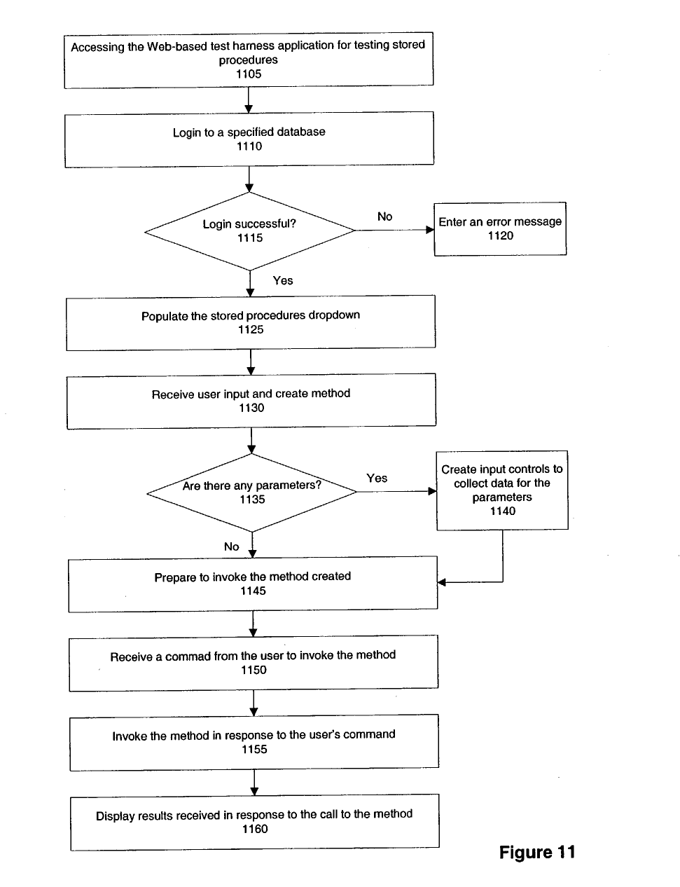

FIG. 11 is a flow diagram conceptually illustrating a test harness process, according to one embodiment. According to one embodiment, a developer may develop a single Web-based test harness application to test all of the stored procedures of a project (project or database). Web-based test harness application may be available on a website for testing the stored procedures. Languages, including the three Visual Studio .NET languages, such as Managed Extensions for C++, Visual Basic, and C#, may be used to develop any number of test harness-related programs.

According to one embodiment, a Uniform Resource Locator (URL) may be obtained for a user to access and use the Web-based stored procedure test harness application. First, a user accesses the Web-based test harness application by accessing the website having the test harness application using a URL via an Internet browser at processing block 1105. At processing block 1110, in order to test a stored procedure of a database, the user may attempt to access the specific database having the stored procedure to be tested. At decision block 1115, whether the login to the specific database is successful is determined. If the login to the specific database is not successful, an error message is entered and displayed at processing block 1120. If the login to the specific database is successful, the stored procedure dropdown is populated with the names of the stored procedures to identify the stored procedures contained in the specific database at processing block 1125. The wait for user input or selection regarding which stored procedure is to be tested begins. At processing block 1130, user selection regarding which stored procedure is to be tested is received and a method may be created.

According to one embodiment, at decision block 1135, parameters are determined. Typically, a parameter may refer to a value used to customize a program for a variety of reasons and purposes, such as organizational necessities, use of the program, system capabilities, user needs, predetermined policy or criteria, and such, or a combination thereof. A parameter may be a coordinate, a file name, a range of values, or a code. Parameters may be required or they may be optional. If the parameters are not found, preparation to invoke the method created begins at processing block 1145. If the parameters are found, input controls may be created to receive user input to collect data for the parameters found at processing block 1135, and, preparation to invoke the method created begins at processing block 1145.

According to one embodiment, waiting for receiving a command from the user begins, and, the command is received from the user for invoking the method at processing block 1150. The method may be invoked in response to the command received from the user, at processing block 1155. Finally, results, including errors or in some cases, only errors, may be received in response to the call to the method and they may be displayed at processing block 1160.

According to one embodiment, any combination of the various hardware and/or software-related components is contemplated, and may be used based on a given circumstances, capabilities, needs, and/or predetermined policy or criteria. It is also contemplated that not all the components are necessary, and several other components may be added, as it will be obvious to the one familiar with the art, based on the disclosure provided.

What is claimed is:

1. A method comprising:
providing a test harness application developed to test a software project, wherein the software project comprises a plurality of distinct functional units; and
testing the plurality of distinct functional units using the test harness application.

2. The method of claim 1, further comprising:
creating a BINary (BIN) directory in the test harness application; and
copying the plurality of distinct functional units to the BIN directory, wherein the plurality of distinct functional units comprises a plurality of assemblies and a plurality of functions.

3. The method of claim 1, further comprising:
generating a Uniform Resource Locator (URL) to access the test harness application; and
visiting the URL to test the software project, wherein the URL is accessed using an Internet browser.

4. The method of claim 1, further comprises using the Microsoft .NET Framework to develop the test harness application.

5. The method of claim 1, further comprising:
finding a dll in the BIN directory;
selecting the dll found in the BIN directory;
finding a class in dll selected;
selecting the class found in the dll selected; and
finding a method in the class selected.

6. The method of claim 5, further comprises not creating a method if the dll, the class, or the method are not found.

7. The method of claim 5, further comprising:
receiving user input from a user;
creating a method in response to the received user input;
finding parameters; and
preparing to invoke the method created in response to the parameters found.

8. The method of claim 7, further comprises creating input controls to collect data to generate parameters if the parameters are not found.

9. The method of claim 5, further comprising:
receiving a command from the user to invoke the method created;
invoking the method created in respond to the command; and
displaying results in response to invoking the method created.

10. A method comprising:
providing a test harness application developed using a .NET Framework-based platform to test a software project;
accessing the test harness application using a Uniform Resource Locator (URL); and
testing the software project using the test harness application.

11. The method of claim 10, wherein the software project comprises a plurality of distinct functional units.

12. The method of claim 11, wherein the plurality of distinct functional units comprises a plurality of assemblies and a plurality of functions.

13. A method comprising:
providing a Web-based test harness application developed to test a database project, wherein the database project comprises a plurality of stored procedures; and
testing the plurality of stored procedures using the Web-based test harness application.

14. The method of claim 13, further comprises using the Microsoft .NET Framework to develop the Web-based test harness application.

15. The method of claim 13, wherein the plurality of stored procedures comprises a plurality of Structured Query Language (SQL) programs.

16. The method of claim 13, further comprises testing the plurality of stored procedures using the Web-based test harness application with a conventional Web application testing tool.

17. A system comprising:
a .NET Framework-based platform to develop a Web-based test harness application;
the Web-based test harness application to test a software project, wherein the software project comprises a plurality of distinct functional units; and
an Internet browser to provide access to the Web-based test harness application.

18. The system of claim 17, wherein the Web-based test harness application is further to test a database project, wherein the database project comprises a plurality of stored procedures.

19. The system of claim 17, further comprises a Uniform Resource Locator (URL) to provide access to the Web-based test harness application via the Internet browser.

20. The system of claim 17, wherein the Internet browser comprises the Internet Explorer or the Netscape Navigator.

21. A machine-readable medium having stored thereon data representing sequences of instructions, the sequences of instructions which, when executed by a machine, cause the machine to:
provide a test harness application developed to test a software project, wherein the software project comprises a plurality of distinct functional units; and
test the plurality of distinct functional units using the test harness application.

22. The machine-readable medium of claim 21, wherein the sequences of instructions which, when executed by the machine, further cause the machine to:
create a BINary (BIN) directory in the test harness application; and
copy the plurality of distinct functional units to the BIN directory, wherein the plurality of distinct functional units comprises a plurality of assemblies and a plurality of functions.

23. The machine-readable medium of claim 21, wherein the sequences of instructions which, when executed by the machine, further cause the machine to:
generate a Uniform Resource Locator (URL) to access the test harness application; and
visit the URL to test the software project, wherein the URL is accessed using an Internet browser.

24. The machine-readable medium of claim 21, wherein the sequences of instructions which, when executed by the machine, further cause the machine to: use the Microsoft NET Framework to develop the test harness application.

25. A machine-readable medium having stored thereon data representing sequences of instructions, the sequences of instructions which, when executed by a machine, cause the machine to:
provide a test harness application developed using a .NET Framework-based platform to test a software project; and
access the test harness application using a Uniform Resource Locator (URL); and
test the software project using the test harness application.

26. The machine-readable medium of claim 25, wherein the software project comprises a plurality of distinct functional units.

27. The machine-readable medium of claim 25, wherein the sequences of instructions which, when executed by the machine, further cause the machine to:
create a BINary (BIN) directory in the test harness application; and
copy the plurality distinct functional units to the BIN directory of the test harness application.

28. A machine-readable medium having stored thereon data representing sequences of instructions, the sequences of instructions which, when executed by a machine, cause the machine to:
provide a Web-based test harness application developed to test a database project, wherein the database project comprises a plurality of stored procedures; and
test the plurality of stored procedures using the Web-based test harness application.

29. The machine-readable medium of claim 28, wherein the plurality of stored procedures comprises a plurality of Structured Query Language (SQL) programs.

30. The machine-readable medium of claim 28, wherein the sequences of instructions which, when executed by the machine, further cause the machine to: test the plurality of stored procedures using the Web-based test harness application with a conventional Web application testing tool.
